(19) United States
(12) Patent Application Publication
(10) Pub. No.: US 2009/0016761 A1
(43) Pub. Date: Jan. 15, 2009

(54) Image Forming Device and Control Method Thereof

(75) Inventors: Satoshi CHIBA, Suwa-shi (JP); Ken IKUMA, Suwa-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/146,290

(22) Filed: Jun. 25, 2008

(30) Foreign Application Priority Data
Jul. 13, 2007 (JP) 2007-184016
Jan. 23, 2008 (JP) 2008-012233

(51) Int. Cl. G03G 15/00; G03G 21/00

(52) U.S. Cl. 399/71; 399/348

(57) ABSTRACT

An image forming device includes a developer carrier for carrying a liquid developer, a latent image carrier to which a latent image is developed by the developer carrier, a charging member for charging the latent image carrier, an exposure device for exposing the latent image carrier, a latent image carrier cleaning roller for applying a bias to clean the latent image carrier, a latent image carrier cleaning blade having contact with the latent image carrier and for scraping out the developer on the latent image carrier, and a cleaning process control section for cleaning the latent image carrier in a condition in which a charging bias of the charging member is applied, the developer carrier has contact with the latent image carrier, and the bias of the latent image carrier cleaning roller is applied to the latent image carrier cleaning roller.

### CROSS REFERENCE TO RELATED APPLICATION

The disclosure of Japanese Patent Applications No. 2007-184016 filed on Jul. 13, 2007 and No. 2008-12233 filed on Jan. 23, 2008 including specification, drawings and claims is incorporated herein by reference in its entirety.

### BACKGROUND

1. Technical Field

The present invention relates to an image forming device using a liquid developer having toner dispersed in a carrier liquid, and a control method of the image forming device.

2. Related Art

A developer used for a wet image forming device has toner particles mixed in an electrical insulating organic solvent, and since the particle diameter of the toner particles is as extremely fine as 2 μm or smaller (typically 1 μm or smaller), which can achieve higher image quality in comparison with a dry image forming device using toner powder with a size of about 7 μm. At the same time, since the toner particles are small, cleanability is lowered.

Therefore, in the past, there has been disclosed an image forming method characterized in that when cleaning the developer remaining on an intermediate transfer belt, by applying a part of the developer thereto for lowering the solid content ratio of the developer with a high solid content ratio remaining on the intermediate transfer belt, and at the same time for dispersing the solid content, the solid content starts being separated from the intermediate transfer belt, and as a result, the cleanability thereof is improved (see JP-A-2007-72358 (Document 1)).

Further, there has been also disclosed an image forming method characterized in that prior to developing the developer on the photoconductor, by applying a voltage to a developer compression member disposed so as to be opposed to a developing roller to compress the toner particles in the developer transported on the developing roller towards the developing roller side, a depth variation in the image section in the developing process is prevented, and at the same time, the fogging in the non-image section in the developing process is prevented (see JP-A-2002-278291 (Document 2)).

However, in the case of cleaning the photoconductor, in contrast with cleaning of the intermediate transfer belt, if compact clusters of the toner particles or the toner particles still remain after slipping through a cleaning blade, the toner particles are charged by the friction between the cleaning blade and the toner particles, and further, by discharging electricity from the toner particles thus charged to the photoconductor, a protective layer on the surface of the photoconductor or even the photoconductor layer, in some cases, might be damaged. The photoconductor in such a condition can hardly be charged normally, and problematically causes faulty printing.

Further, if the photoconductor surface is contaminated by faulty cleaning, when an electric latent image is formed on the surface of the photoconductor by an exposure device, there is caused a problem that the exposure light is diffused to disturb the latent image or a problem that the electric latent image formed of the surface of the photoconductor can hardly be maintained.

Further, in the case in which the toner particles remains on the surface of the photoconductor as disclosed in Document 2, since the toner particles remaining on the photoconductor form compact clusters, it becomes further difficult to remove them by cleaning with a normal cleaning blade, and accordingly, such toner particles forming the compact clusters cannot be cleaned but slip through the cleaning blade to cause the problem of damaging the surface of the photoconductor.

### SUMMARY

The invention has an advantage of solving the problems described above, and improving cleanability of a latent image carrier, thus providing an image forming device with preferable image quality and a control method of such an image forming device.

According to an aspect of the invention, there is provided an image forming device including a developer carrier for carrying a liquid developer, a latent image carrier to which a latent image is developed by the developer carrier, a charging member for charging the latent image carrier, an exposure device for exposing the latent image carrier, a latent image carrier cleaning roller for applying a bias to clean the latent image carrier, a latent image carrier cleaning blade having contact with the latent image carrier and for scraping out the developer on the latent image carrier, and a cleaning process control section for cleaning the latent image carrier in a condition in which a charging bias of the charging member is applied, the developer carrier has contact with the latent image carrier, and the bias of the latent image carrier cleaning roller is applied to the latent image carrier cleaning roller. Therefore, the cleanability of the residual solid content not transferred can be improved, thus the breakage of the protective layer or a photoconductive layer in the surface layer of the latent image carrier can be suppressed.

Further, a developer compression member for compressing the developer on the developer carrier is provided, and the cleaning process control section keeps stopping application of biases to the developer carrier and the developer compression member. Therefore, an image can preferably be formed in the printing state, and in the cleaning process, the developer is not compressed, thus the cleanability can be improved.

Further, the developer carrier, the latent image carrier, the charging member, the exposure device, the latent image carrier cleaning roller, and the latent image carrier cleaning blade are provided for each of a plurality of developers with respective colors. Therefore, the cleaning process corresponding to the developer of each color can be executed.

Further, the cleaning process control section separates the latent image carrier cleaning blade from the latent image carrier, applies the bias to the latent image carrier cleaning roller, and then makes the latent image carrier cleaning blade have contact with the latent image carrier. Therefore, by making the latent image carrier cleaning blade have contact therewith in the condition in which the latent image carrier cleaning roller applies the bias to the aggregated developer to make the developer easy to be scraped out, the cleanability can be improved.

Further, a transfer member having a transfer bias applying section for applying a bias for transferring the image on the latent image carrier is provided, and the cleaning process control section executes the cleaning process while separating the transfer member from the latent image carrier. Therefore, it is suppressed that the developer is attached to the transfer member.

Further, the latent image carrier cleaning roller applies the bias with the same polarity as the polarity of the bias applied to the transfer bias applying section when the image on the latent image carrier is transferred. Therefore, it becomes easy to recover the developer by the latent image carrier cleaning roller, thus the cleanability can be improved.

Further, a transfer member having a transfer bias applying section for applying a bias for transferring the image on the latent image carrier is provided, and the cleaning process control section executes the cleaning process while the transfer member has contact with the latent image carrier. Therefore, the developer on the latent image carrier is transferred to the transfer member, and thus the cleanability of the latent image carrier can be improved.

Further, the latent image carrier cleaning roller applies the bias with the reverse polarity from the polarity of the bias applied to the transfer bias applying section when the image on the latent image carrier is transferred. Therefore, the developer regularly charged is transferred to the transfer member while the developer not regularly charged is recovered by the latent image carrier cleaning roller, thus the cleanability can be improved.

Further, a squeezing member for recovering a carrier liquid on the latent image carrier is provided, and the cleaning process control section separates the squeezing member therefrom. Therefore, the recovery of the carrier liquid is reduced, thus it becomes easy to scrape out the developer with the latent image carrier cleaning blade or the like.

Further, the squeezing member includes a first squeezing roller and a second squeezing roller. Therefore, the carrier liquid can sufficiently be removed in the printing state, thus the image quality can be improved.

### BRIEF DESCRIPTION OF THE DRAWINGS

The invention will now be described with reference to the accompanying drawings, wherein like numbers refer to like elements.

FIG. 1 is a diagram showing an image forming device.

FIG. 2 is a diagram showing a developing unit of the image forming device.

FIG. 3 is a diagram showing a developing unit using a developer compression roller.

FIGS. 4A and 4B are diagrams showing a developer supply roller.

FIG. 5 is a diagram showing a first embodiment of cleaning control.

FIG. 6 is a diagram showing a developing unit of the image forming device.

FIG. 7 is a diagram showing a developing unit of the image forming device.

FIG. 8 is a diagram showing a developing unit of the image forming device.

FIG. 9 is a diagram showing a second embodiment of the cleaning control.

FIG. 10 is a diagram showing an image forming device.

FIG. 11 is a diagram showing a third embodiment of the cleaning control.

FIG. 12 is a diagram showing an image forming device with another structure.

FIG. 13 is a diagram showing a developing unit of the image forming device with the another structure.

FIG. 14 is a diagram showing a nip section of a squeezing roller.

FIG. 15 is a diagram showing a fourth embodiment of the cleaning control.

FIG. 16 is a diagram showing a developing unit of the image forming device with the another structure.

FIG. 17 is a diagram showing a fifth embodiment of the cleaning control.

FIG. 18 is a diagram showing the image forming device with the another structure.

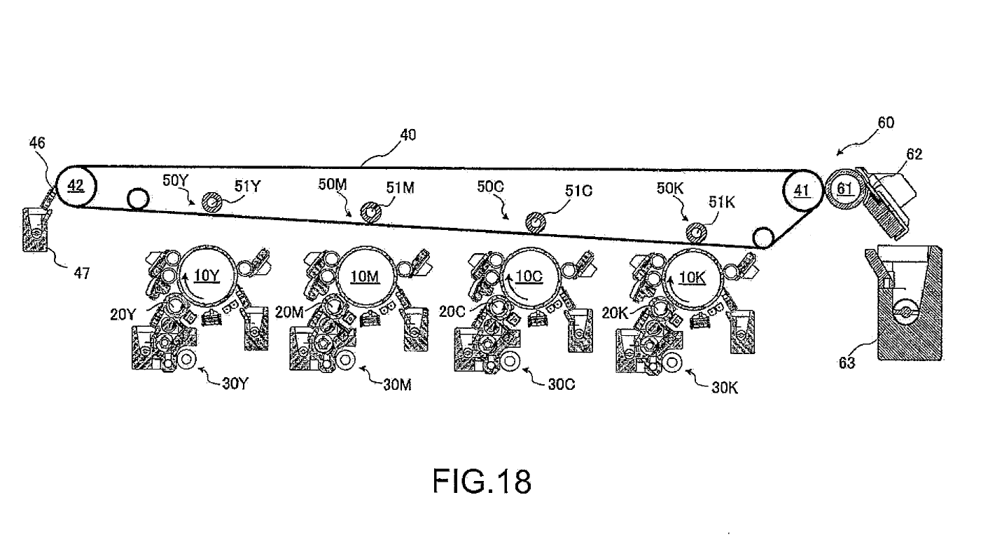

FIG. 19 is a diagram showing the image forming device with the another structure.

FIG. 20 is a diagram showing a sixth embodiment of the cleaning control.

FIG. 21 is a diagram showing a seventh embodiment of the cleaning control.

FIG. 22 is a diagram showing a developing unit of the image forming device with the another structure.

FIG. 23 is a diagram showing a developing unit of the image forming device with the another structure.

FIG. 24 is a diagram showing the image forming device with the another structure.

FIG. 25 is a diagram showing the image forming device with the another structure.

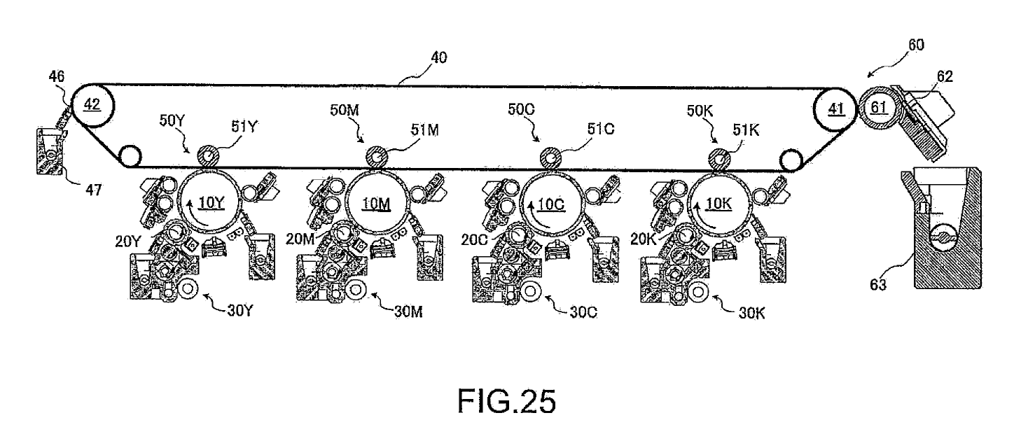

### DESCRIPTION OF EXEMPLARY EMBODIMENTS

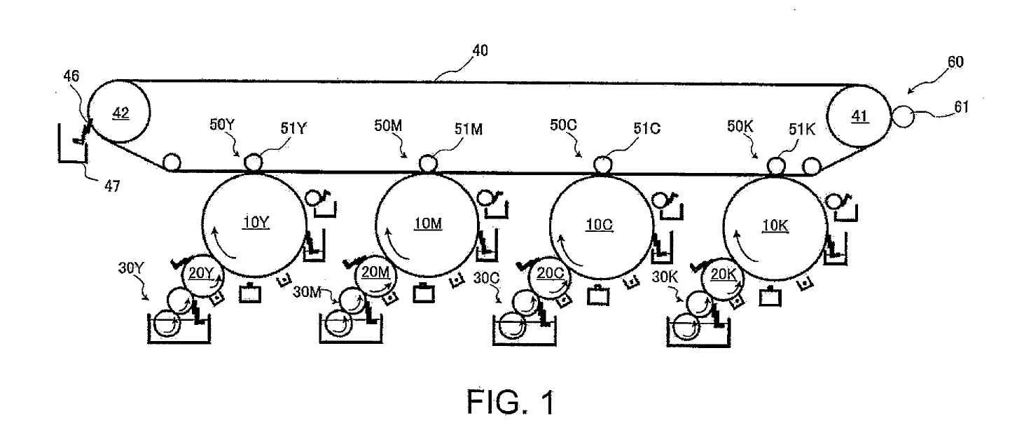

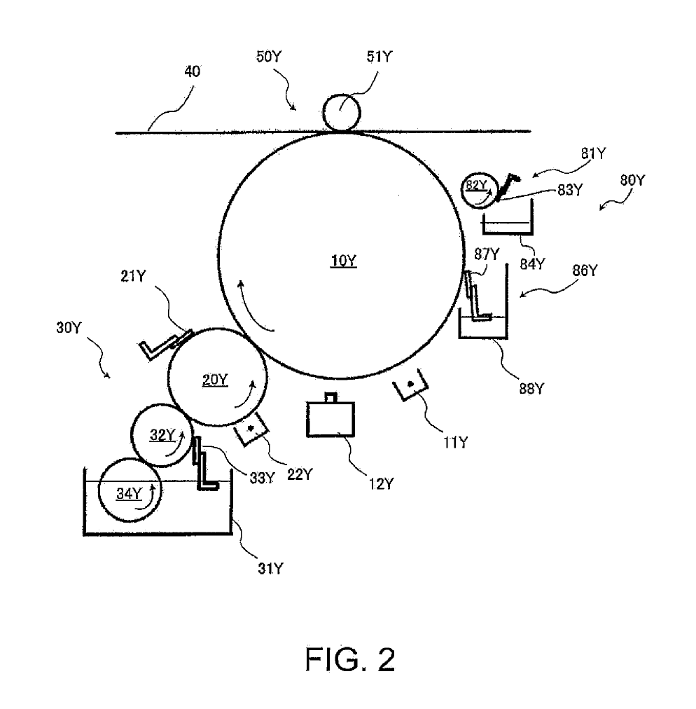

Embodiments of the invention will hereinafter be explained with reference to the accompanying drawings. FIG. 1 is a diagram showing principal constituents composing an image forming device according to an embodiment of the invention, and FIG. 2 is a cross-sectional view showing a primary transfer section and principal constituents of a developing unit as an example of a developing device. In FIG. 1, the image forming section and the developing unit have the same constituents for respective colors of yellow (Y), magenta (M), cyan (C), and black (K) denoted with the same numbers attached with letters Y, M, C, and K representing the respective colors. Among these constituents, FIG. 2 selectively shows the constituents of the image forming section and the developing unit with respect to yellow (Y). Hereinafter, details of each of the image forming section and the developing unit will be explained with reference to FIG. 2.

The photoconductor 10Y as an example of the latent carrier is formed of a cylindrical member with a diameter of about 80 mm, and carries an image with the liquid developer. A photoconductor cleaning unit 80Y as an example of a latent image carrier cleaning unit, a charger 11Y as an example of a charging member for charging the photoconductor 10Y, an exposure unit 12Y as an example of an exposure device for exposing the photoconductor 10Y, and a developing roller 20Y as an example of a developer carrier of the developing unit 30Y are disposed along a rotational direction (moving direction) of the outer periphery of the photoconductor 10Y.

The photoconductor cleaning unit 80Y has a first photoconductor cleaning device 81Y and a second photoconductor cleaning device 86Y disposed downstream thereof in the moving direction of the photoconductor.

The first photoconductor cleaning device 81Y has a photoconductor cleaning roller 82Y as an example of a latent image carrier cleaning roller having a cylindrical shape with a diameter of about 20 mm, a photoconductor cleaning roller blade 83Y as an example of a latent image carrier cleaning roller blade for scraping out the developer on the photoconductor cleaning roller 82Y disposed on the outer periphery thereof, and a first photoconductor developer recovery section 84Y as an example of a first latent image carrier developer recovery section for recovering the developer thus scraped out therefrom. The photoconductor cleaning roller 82Y is disposed so as to be contacted to and separated from the photoconductor 10Y. It should be noted that the photoconductor cleaning roller 82 can be arranged to be moved integrally with the first photoconductor cleaning device 81Y, or moved integrally with the photoconductor cleaning roller blade 83Y.

The second photoconductor cleaning device 86Y has a photoconductor cleaning blade 87Y as an example of a latent image carrier cleaning blade for contacting the photoconductor 10Y to scrape out the developer on the photoconductor 10Y, and a second photoconductor developer recovery section 88Y as an example of a second latent image carrier developer recovery section for recovering the developer thus scraped out by the photoconductor cleaning blade 87Y. The photoconductor cleaning blade 87Y is disposed so as to be contacted to and separated from the photoconductor 10Y.

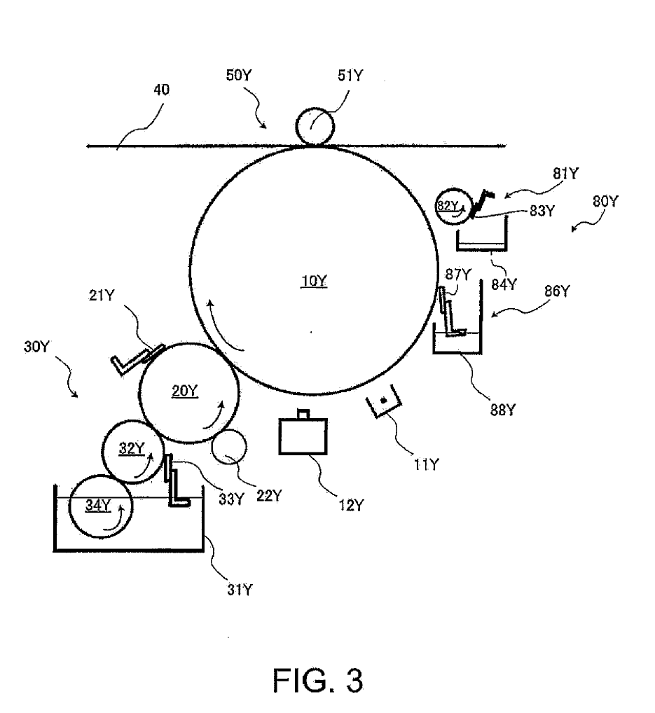

The developing unit 30Y has a developing roller cleaning blade 21Y as an example of a developer carrier cleaning section, a developer supply roller 32Y using an anilox roller as an example of a developer supply member and a regulating blade 33Y for regulating the supply amount of the developer thereof, and a developer compression member 22Y as an example of a developer compression corona device disposed on the outer periphery of a developing roller 20Y having a cylindrical shape with a diameter of about 30 mm, and has a developer agitating supplying roller 34Y for agitating the developer to be in an evenly dispersed condition and supplying the developer supply roller 32Y with the developer disposed in a developer reservoir 31Y containing the liquid developer. It should be noted that as shown in FIG. 3, the developer compression roller 22Y can be used as the developer compression member.

Further, a primary transfer roller 51Y of a primary transfer section 50Y is disposed at a position across the intermediate transfer belt 40 from the photoconductor 10Y, and the primary transfer sections 50 (M, C, K) are further disposed along the intermediate transfer belt 40 downstream thereof in the moving direction of the intermediate transfer belt 40.

The liquid developer reserved in the developer reservoir 31Y is a high-viscosity (about 30 through 10000 mPa·s) having solid matters, which have an average particle diameter of 1 μm and have a colorant such as a pigment dispersed in thermoplastic resin, added to a liquid solvent such as an organic solvent, silicone oil, mineral oil, or edible oil together with a dispersant to have a toner solid content concentration of about 25%.

In the image forming section and the developing unit 30Y, the photoconductor charger 11Y charges the photoconductor 10Y evenly, the exposure unit 12Y such as a line head irradiates the photoconductor with the laser beam modulated in accordance with an image signal input therein, thus an electrostatic latent image on the photoconductor 10Y thus charged. Further, the developer is supplied from the developer reservoir 31Y for reserving the liquid developer of the respective colors (yellow in this case) to the developing roller 20Y via the developer supply roller 32Y while regulating the supply amount of the developer by the regulating blade 33Y, thus developing the electrostatic latent image formed on the photoconductor 10Y.

The intermediate transfer belt 40 is an endless belt member or the like, wound around a drive roller 41 and a tension roller 42 so as to be stretched across these rollers, and rotationally driven by the drive roller 41 while having contact with the photoconductors 10Y, 10M, 10C, and 10K at the primary transfer sections 50Y, 50M, 50C, and 50K, respectively. The primary transfer sections 50Y, 50M, 50C, and 50K have primary transfer rollers 51Y, 51M, 51C, and 51K disposed across the intermediate transfer belt 40 from the photoconductors 10Y, 10M, 10C, and 10K, respectively, and forms a full-color toner image by sequentially stacking on the intermediate transfer belt 40 the toner images of respective colors on the photoconductors 10Y, 10M, 10C, and 10K thus developed at transfer positions at which the intermediate transfer belt 40 and the photoconductors 10Y, 10M, 10C, and 10K have contact, respectively The intermediate transfer belt 40 carries the toner images, which is thus formed on the plurality of latent image carriers (photoconductors) 10Y, 10M, 10C, and 10K, sequentially primarily transferred in a overlapping manner, and the toner images are secondarily transferred in a lump to a sheet member as an example of a transfer member or a recording medium.

The secondary transfer unit 60 has a secondary transfer roller 61 disposed across the intermediate transfer belt 40 from a belt drive roller 41. In the secondary transfer unit 60, the sheet member such as a form, a film, or cloth is fed and supplied through a sheet member transport path L with the timing with which the full-color toner image formed by stacking colors on the intermediate transfer belt 40 or a monochroic toner image reach a transfer position of the secondary transfer unit 60, and the monochroic toner image or the full-color toner image is secondarily transferred to the sheet member. A fixing unit, not shown, is disposed in front of a sheet member transport path, not shown, for melting the monochroic toner image or the full-color toner image transferred onto the sheet member to be fixed on the recording medium (the sheet member) such as a form, thus terminating the final image forming process in the sheet member. The secondary transfer roller 61 is also composed of an elastic roller having a surface coated with an elastic member as a measure for improving the secondary transfer characteristics by deforming itself along even a non-smooth surface of a sheet member made of fibers. This arrangement is adopted for the same purpose as the purpose of an elastic belt member adopted to the intermediate transfer belt 40 for carrying the toner images formed on the plurality of photoconductors 10Y, 10M, 10C, and 10K and sequentially primarily transferred to the intermediate transfer belt 40, and secondarily transferring the sheet member to the sheet member in a lump.

On the side of the tension roller 42 which applies tension to the intermediate transfer belt 40 in cooperation with the belt drive roller 41, there is disposed along the outer periphery thereof an intermediate transfer belt cleaning device composed mainly of an intermediate transfer belt cleaning blade 46 disposed so as to have contact with the intermediate transfer belt 40 and an intermediate transfer belt developer recovery section 47. The intermediate transfer belt 40 passing through the secondary transfer unit 60 proceeds to a winding section of the tension roller 42 for executing cleaning on the intermediate transfer belt 40 by the intermediate transfer belt cleaning blade 46, and then proceeds towards the primary transfer sections 50.

The transfer member is mainly composed of the intermediate transfer belt 40, the belt drive roller 41, the tension roller 42, the intermediate transfer belt cleaning blade 46, the intermediate transfer belt developer recovery section 47, the primary transfer sections 50Y, 50M, 50C, and 50K, and the secondary transfer section 60.

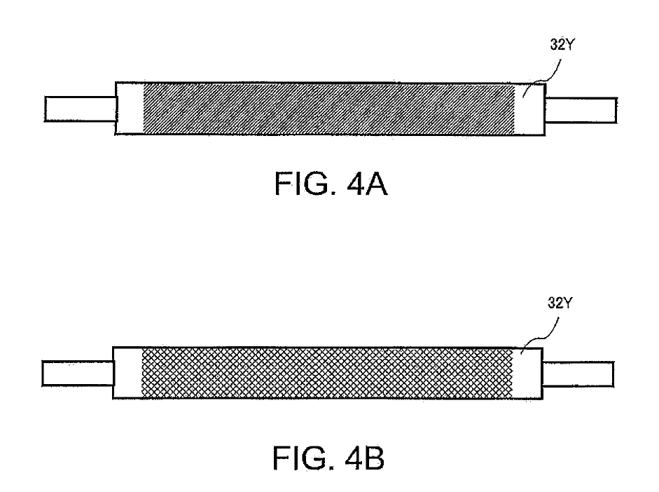

FIGS. 4A and 4B are diagrams showing the developer supply roller 32Y of the present embodiment. The developer supply roller 32Y according to the present embodiment is mainly composed of an anilox roller which is a cylindrical member with a diameter of about 20 mm, rotated counterclockwise as shown in FIG. 2, and provided with a spiral groove pattern or a cell pattern finely and evenly formed on the surface thereof. The groove has sizes of about 150 μm in groove pitches and about 30 μm in groove depth.

Hereinafter, the photoconductor cleaning process control will be explained. The photoconductor cleaning control is performed for removing the developer remaining on the surface of the photoconductor 10Y.

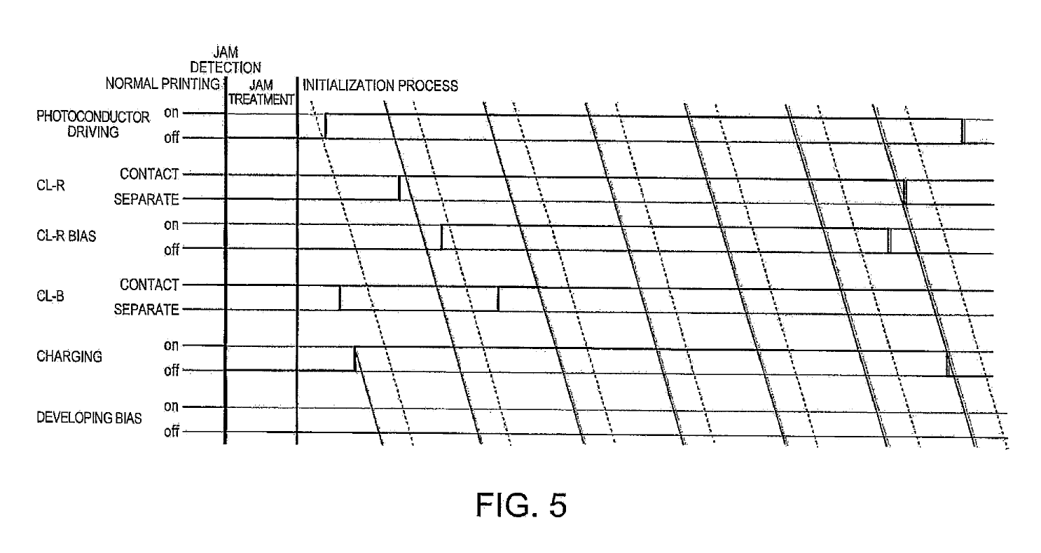

FIG. 5 shows a timing chart of a first embodiment of the photoconductor cleaning control. It should be noted that solid slant lines each represent a front edge position of the charged area, and dotted slant lines each represent a front edge position of the toner not yet transferred.

Firstly, in a printing state, as shown in FIG. 2, the photoconductor 10Y is driven, a charging bias of about +600 V and a developing bias of about +400 V are both applied in ON states, the photoconductor cleaning roller 82Y is separated with no bias applied, namely with the bias in an OFF state, and the photoconductor cleaning blade 87Y is contacted thereto.

In this condition, the liquid developer supplied from the agitating supplying roller 34Y to the developer supply roller 32Y is regulated by the regulating blade 33Y to be in a condition in which the amount of developer is adjusted, and then the liquid developer is transferred to the developing roller 20Y, and further to the portions of the photoconductor 10Y on which the latent image is formed, thus developing the latent image. The potential of the exposed photoconductor 10Y is assumed to be about +100 V. The liquid developer provided to the photoconductor 10Y as the developed image is transferred to the intermediate transfer belt 40 at the primary transfer section 50Y.

The toner and the carrier liquid not primarily transferred and remaining on the photoconductor 10Y are removed by the photoconductor cleaning blade 87Y.

When a jam is detected, the drive of the photoconductor 10Y, the charging bias, and the developing bias are kept OFF while treating the jam.

After the treatment of the jam, an initialization process is commenced. In the initialization process, the developer compression member 22Y is not applied in order for preventing aggregation of the solid content of the developer.

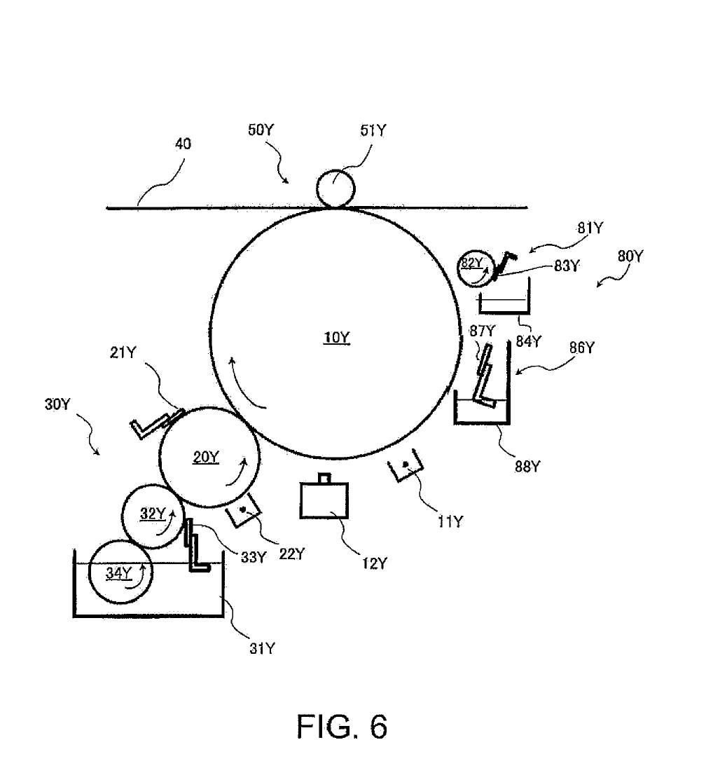

Firstly, the photoconductor 10Y is driven to start the rotational operation. Then, the photoconductor cleaning blade 87Y is separated as shown in FIG. 6 prior to the residual developer on the photoconductor 10Y reaching the photoconductor cleaning section 80Y. Then, charging is turned ON to charge the developer remaining on the surface of the photoconductor 10Y again to the charging polarity in the printing condition. In this case, in order for preventing the solid content of the residual developer on the photoconductor 10Y from being shifted to the side of the photoconductor 10Y, the process can be executed with a weaker charging bias than the charging bias in the printing condition.

After the charging process, by supplying the developer not yet compressed by the developer compression member 22Y from the developing roller 20Y to the photoconductor 10Y, the compressed condition of the developer remaining on the surface of the photoconductor 10Y is weakened to attain the condition in which the cleaning can easily be performed. In this condition, some of the developer is transferred in the primary transfer section 50Y to decrease the concentration of the solid content of the developer remaining on the photoconductor 10Y. The transfer bias of the primary transfer section 50Y in this case can be set lower than the transfer bias in the printing operation in order for transferring only a part of the solid content of the developer.

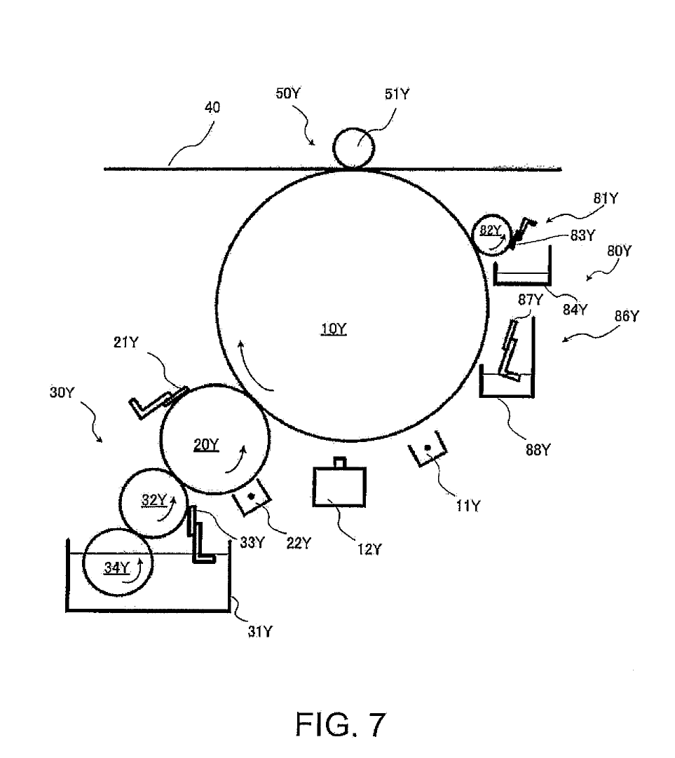

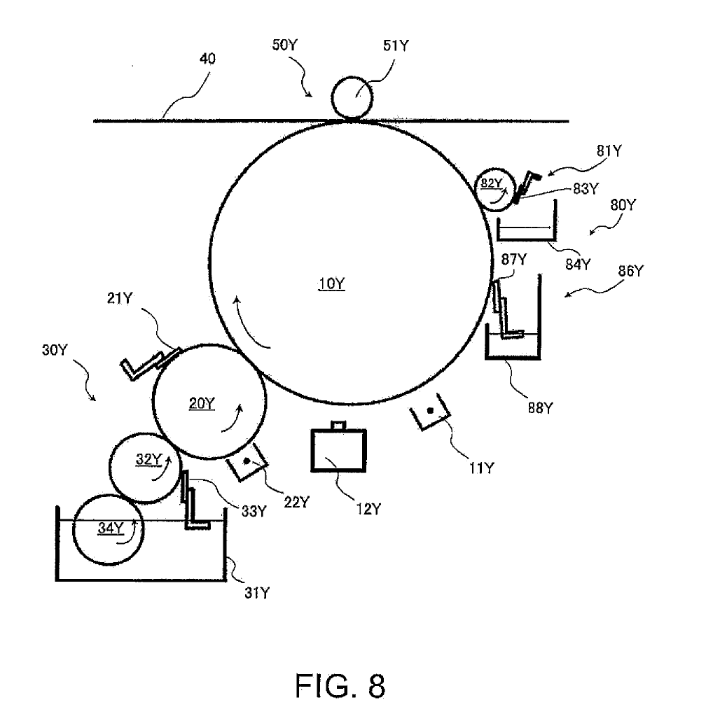

Then, as shown in FIG. 7, by making the photoconductor cleaning roller 82Y have contact with the photoconductor 10Y and applying a bias of about −300 V thereto, the concentration of the solid content of the developer remaining on the surface of the photoconductor 10Y is further lowered. Subsequently, as shown in FIG. 8, the photoconductor cleaning blade 87Y is made have contact with the surface of the photoconductor 10Y to remove the developer remaining on the surface of the photoconductor 10Y.

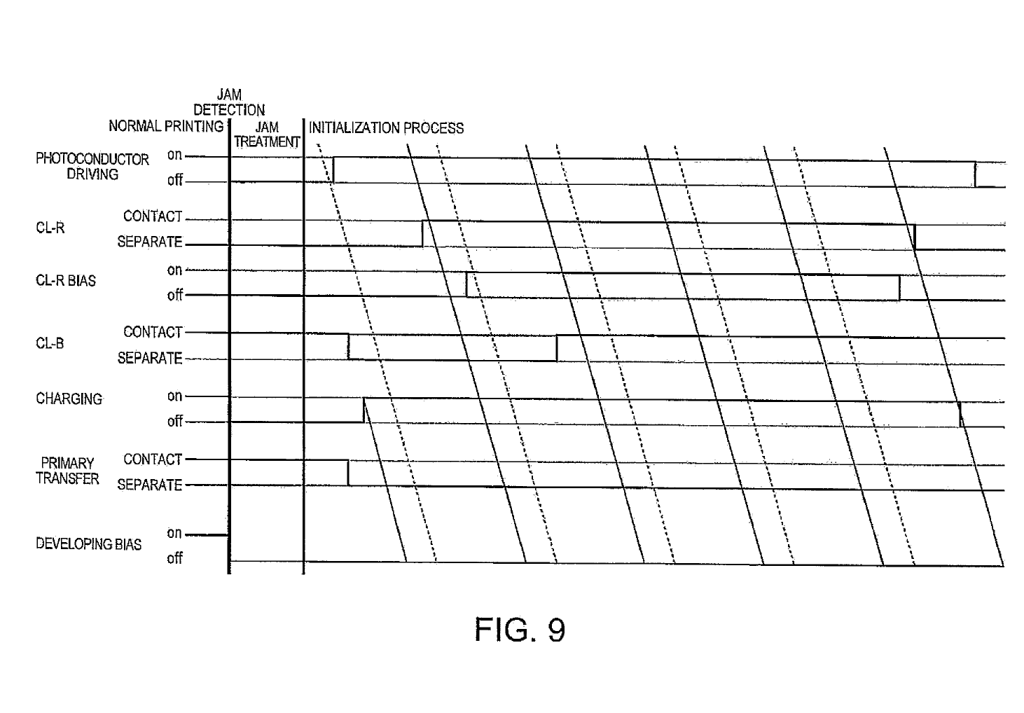

Then, a second embodiment of the photoconductor cleaning control will hereinafter be explained. FIG. 9 shows a timing chart of the second embodiment of the photoconductor cleaning control. It should be noted that solid slant lines each represent a front edge position of the charged area, and dotted slant lines each represent a front edge position of the toner not yet transferred.

Firstly, in the printing state, as shown in FIG. 2, the photoconductor 10Y is driven, a charging bias of about +600 V and a developing bias of about +400 V are both in ON states, the photoconductor cleaning roller 82Y is separated with no bias is applied, namely with the bias in an OFF state, and the photoconductor cleaning blade 87Y is contacted thereto.

In this condition, the liquid developer supplied from the agitating supplying roller 34Y to the developer supply roller 32Y is regulated by the regulating blade 33Y to be in a condition in which the amount of developer is adjusted, and then the liquid developer is transferred to the developing roller 20Y, and further to the portions of the photoconductor 10Y on which the latent image is formed, thus developing the latent image. The potential of the exposed photoconductor 10Y is assumed to be about +100 V. The liquid developer provided to the photoconductor 10Y as the developed image is transferred to the intermediate transfer belt 40 at the primary transfer section 50Y.

The toner and the carrier liquid not primarily transferred and remaining on the photoconductor 10Y are removed by the photoconductor cleaning blade 87Y.

When a jam is detected, the drive of the photoconductor 10Y, the charging bias, and the developing bias are kept OFF while treating the jam.

After the treatment of the jam, an initialization process is commenced. In the initialization process, the developer compression member 22Y is not applied in order for preventing aggregation of the solid content of the developer.

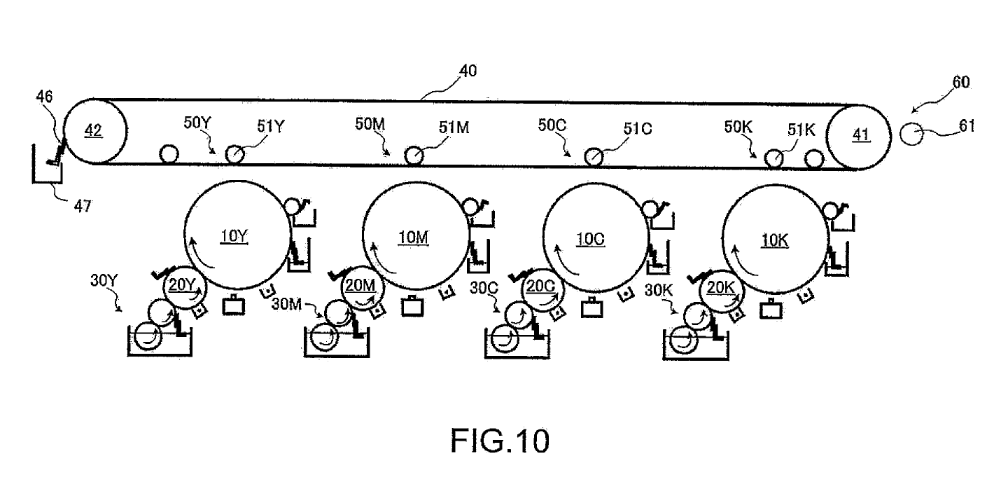

Firstly, the photoconductor 10Y is driven to start the rotational operation, and at the same time, as shown in FIG. 10, the primary transfer sections 50Y, 50M, 50C, and 50K are separated from the belt. On this occasion, the secondary transfer section 60 can also be separated. Then, the photoconductor cleaning blade 87Y is separated as shown in FIG. 6 prior to the residual developer on the photoconductor 10Y reaching the photoconductor cleaning section 80Y. Then, charging is turned ON to charge the developer remaining on the surface of the photoconductor 10Y again to the charging polarity in the printing condition. In this case, in order for preventing the solid content of the residual developer on the photoconductor 10Y from being shifted to the side of the photoconductor 10Y, the process can be executed with a weaker charging bias than the charging bias in the printing condition.

After the charging process, by supplying the developer not yet compressed by the developer compression member 22Y from the developing roller 20Y to the photoconductor 10Y, the compressed condition of the developer remaining on the surface of the photoconductor 10Y is weakened to attain the condition in which the cleaning can easily be performed.

Then, as shown in FIG. 7, by making the photoconductor cleaning roller 82Y have contact with the photoconductor 10Y and applying a bias of about −300 V thereto, the concentration of the solid content of the developer remaining on the surface of the photoconductor 10Y is further lowered. Subsequently, as shown in FIG. 8, the photoconductor cleaning blade 87Y is made have contact with the surface of the photoconductor 10Y to remove the developer remaining on the surface of the photoconductor 10Y.

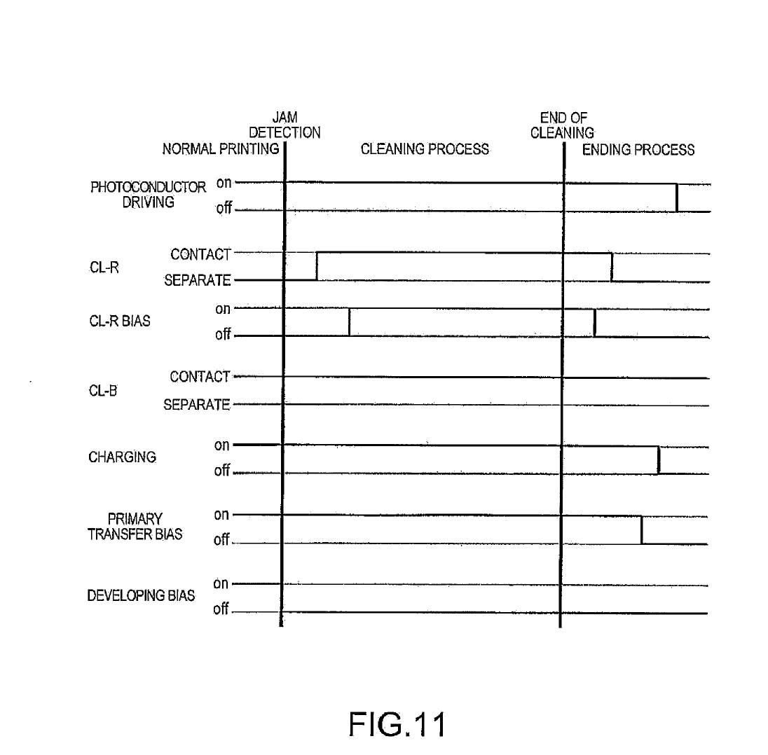

Then, a third embodiment of the photoconductor cleaning control will hereinafter be explained. FIG. 11 shows a timing chart of the third embodiment of the photoconductor cleaning control.

Firstly, in a printing state, as shown in FIG. 2, the photoconductor 10Y is driven, a charging bias of about +600 V and a developing bias of about +400 V are both applied in ON states, the photoconductor cleaning roller 82Y is separated with no bias applied, namely with the bias in an OFF state, and the photoconductor cleaning blade 87Y is contacted thereto.

In this condition, the liquid developer supplied from the agitating supplying roller 34Y to the developer supply roller 32Y is regulated by the regulating blade 33Y to be in a condition in which the amount of developer is adjusted, and then the liquid developer is transferred to the developing roller 20Y, and further to the portions of the photoconductor 10Y on which the latent image is formed, thus developing the latent image. The potential of the exposed photoconductor 10Y is assumed to be about +100 V. The liquid developer provided to the photoconductor 10Y as the developed image is transferred to the intermediate transfer belt 40 at the primary transfer section 50Y.

The toner and the carrier liquid not primarily transferred and remaining on the photoconductor 10Y are removed by the photoconductor cleaning blade 87Y.

In the present embodiment, when a jam is detected, the cleaning process and a stopping process are executed. In the cleaning process and the stopping process, the developer compression member 22Y is not applied in order for preventing aggregation of the solid content of the developer.

When the jam is detected, the cleaning process is commenced. Firstly, the photoconductor 10Y is continued to be driven similarly to the printing state. Then, the photoconductor cleaning blade 87Y is made have contact therewith and the bias of about −300 V is applied thereto as shown in FIG. 8 prior to the residual developer on the photoconductor 10Y reaching the photoconductor cleaning section 80Y. The cleaning process is terminated after the photoconductor 10Y makes at least one revolution.

Then, the stopping process is performed. In the stopping process, as shown in FIG. 2, firstly the photoconductor cleaning roller 82Y is separated therefrom, and the bias is turned OFF. Then, the bias of the charging section 11Y and the primary transfer section SOY is turned OFF. After then, the drive of the photoconductor 10Y is stopped. During the above process, the cleaning blade 87Y are kept contacting the photoconductor.

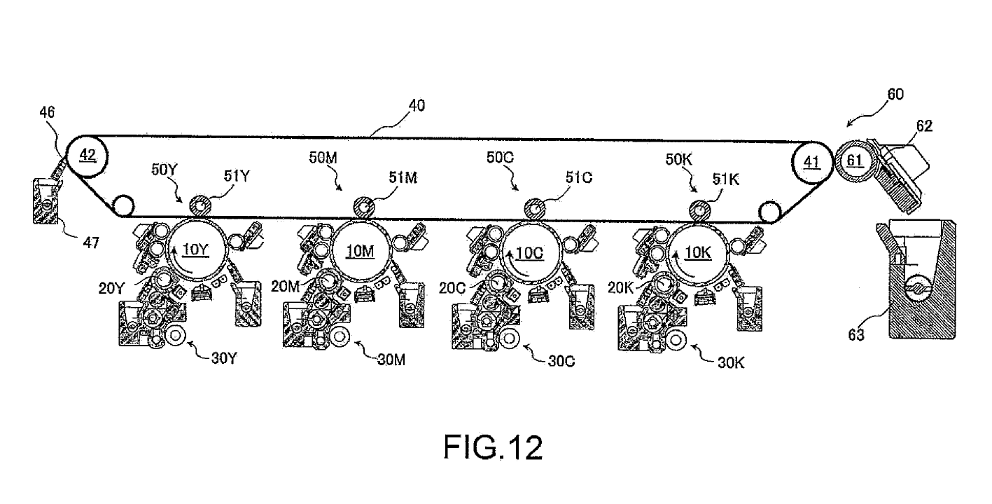

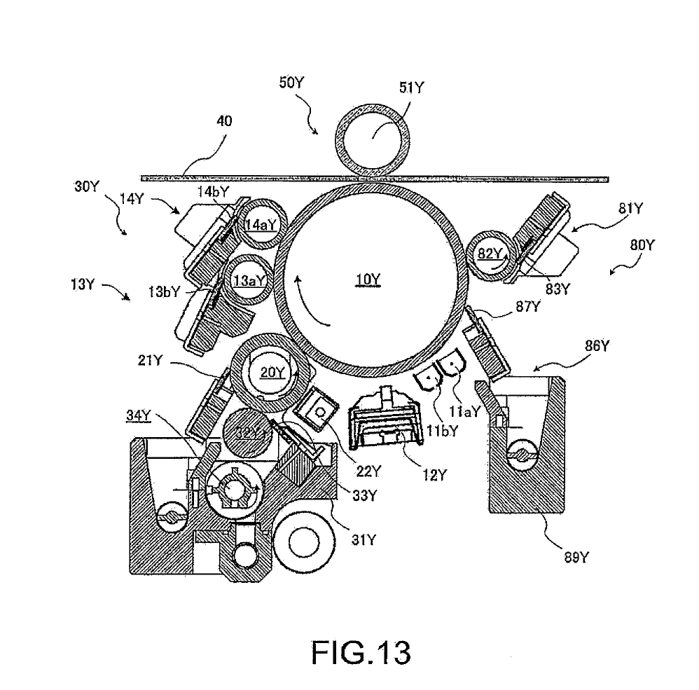

Then, embodiments with another structure of the invention will now be explained. FIG. 12 is a diagram showing a second structure of an image forming device according to an embodiment of the invention, and FIG. 13 is a cross-sectional view showing principal constituents of a developing unit 30Y as an example of the primary transfer section 50Y and the developing device 30Y.

Since the image forming device 1 shown in FIGS. 12 and 13 is substantially the same as the image forming device 1 shown in FIG. 1, only different constituents will be explained here, and explanations for the common sections will be omitted.

The image forming device 1 shown in FIGS. 12 and 13 has a configuration including two chargers, a first charger 11a and a second charger 11b, as the charger 11 for each of the colors, added with a first squeezing roller 13, a second squeezing roller 14, a secondary transfer roller cleaning blade 62, and a secondary transfer developer recovery section 63, and having a photoconductor cleaning/developer recovery section 89Y formed by integrating the first photoconductor developer recovery section 84Y and the second photoconductor developer recovery section 88Y of the image forming device 1 shown in FIG. 1.

The secondary transfer roller cleaning blade 62 is a member for cleaning the surface of the second transfer roller 62, and the developer scraped out therefrom is recovered by the secondary transfer developer recovery section 63.

FIG. 13 is a diagram showing a configuration of the primary transfer section 50Y and the developing unit 30Y for yellow (Y). Hereinafter, details of each of the primary transfer section 50Y and the developing unit 30Y will be explained with reference to FIG. 13.

Then, the squeezing device as a carrier removal device will be explained. The squeezing device according to the present embodiment has a first squeezing device 13 and a second squeezing device 14, and is disposed downstream of the developing roller 20Y while opposed to the photoconductor 10Y, and for always having contact with the photoconductor 10Y to recover the surplus developer other than the toner image thus developed.

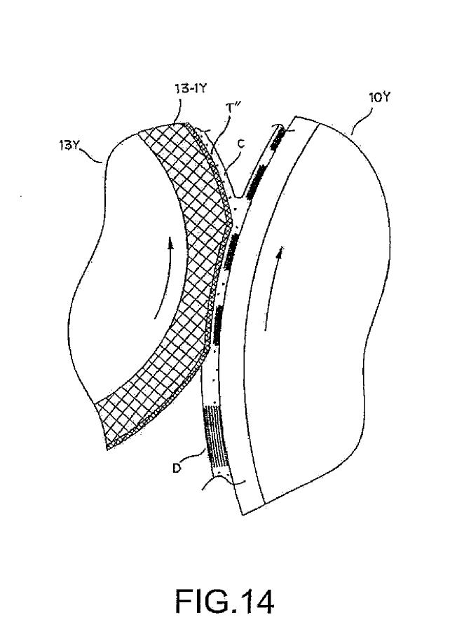

The first squeezing device 13 is mainly composed of a first squeezing roller 13aY formed of an elastic roller member having a surface covered with a first elastic member 13a-1Y and rotating while slidably contacting the photoconductor 10Y as shown in FIG. 14, and a first squeezing roller cleaning blade 13bY pressed against and slidably contacting the first squeezing roller 13aY for cleaning the surface thereof as shown in FIG. 13.

Further, the second squeezing device 14, similarly to the first squeezing device 13 shown in FIG. 14, is mainly composed of a second squeezing roller 14aY formed of an elastic roller member having a surface covered with a second elastic member 14a-1Y and rotating while slidably contacting the photoconductor 10Y, and a second squeezing roller cleaning blade 14bY pressed against and slidably contacting the second squeezing roller 14aY for cleaning the surface thereof as shown in FIG. 13. The squeezing devices 13Y, 14Y have a function of recovering surplus carrier liquid C and the superfluous toner T″, which is fundamentally unnecessary, from the developer D developed on the photoconductor 10Y to increase the toner particle ratio in a visible image. The capacity of recovering the surplus carrier liquid C can be set to a desired recovery capacity by setting a rotational direction of the first squeezing roller 13aY and the second squeezing roller 14aY, and a relative circumferential velocity difference of the first squeezing roller 13aY and the second squeezing roller 14aY with respect to the circumferential velocity of the photoconductor 10Y, and when rotating them in a counter rotational direction with respect to the rotational direction of the photoconductor 10Y, the recovery capacity increases, further, when setting the velocity difference larger, the recovery capacity also increases, and still further, the synergetic effect thereof can also be obtained.

The surplus carrier liquid C and the unnecessary superfluous toner T″ recovered by the first squeezing roller 13aY and the second squeezing roller 14aY are dropped from the first squeezing roller 13aY and the second squeezing roller 14aY to the developer reservoir 31Y by the action of the first squeezing roller cleaning blade 13bY and the second squeezing roller cleaning blade 14bY, and are recovered by the developer recycling device, not shown. It should be noted that since the surplus carrier liquid C and the superfluous toner T″ thus recovered are recovered from the photoconductor 10Y isolated from the other colors, a color mixture phenomenon is not caused in all of the sections.

Since the charging member 11 is provided with the two chargers, namely the first charger 11a and the second charger 11b, the charged voltage can be set more precisely such that both are turned ON, one is turned ON while the other is turned OFF, both are turned OFF, or each of the outputs is set a half thereof.

Further, by integrating the first photoconductor developer recovery section 84Y and the second photoconductor developer recovery section 88Y to the common section, and arranging that the developer scraped out by the photoconductor cleaning roller blade 83Y and the photoconductor cleaning roller blade 87Y is recovered by the photoconductor cleaning developer recovery section 89Y, the number of components can be reduced.

Hereinafter, the photoconductor cleaning process control will be explained. The photoconductor cleaning control is performed for removing the developer remaining on the surface of the photoconductor 10Y.

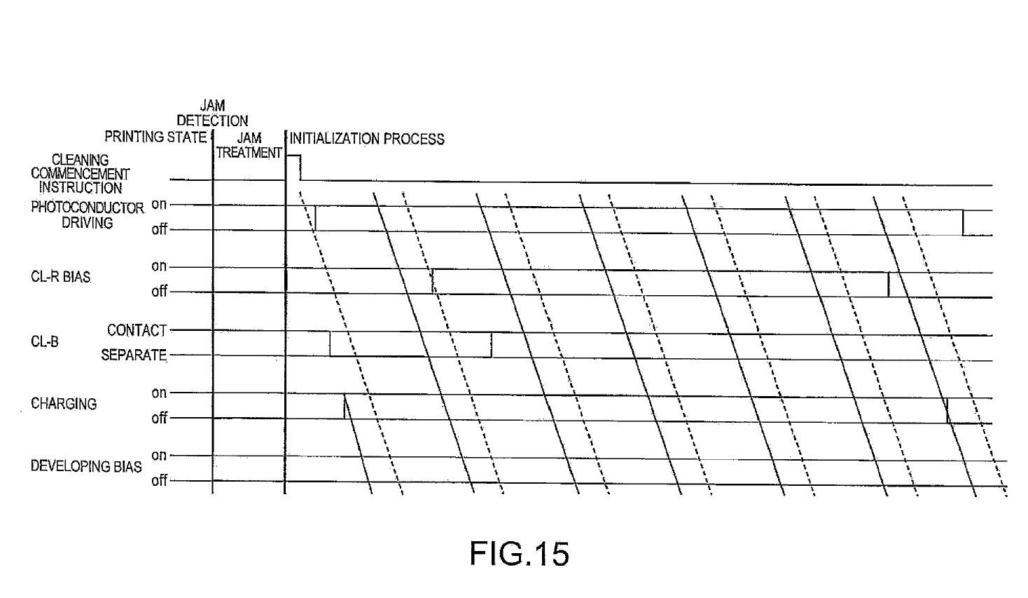

FIG. 15 shows a timing chart of the fourth embodiment of the photoconductor cleaning process control.

It should be noted that solid slant lines each represent a front edge position of the charged area, and dotted slant lines each represent a front edge position of the toner not yet transferred.

Firstly, in a printing state, the photoconductor 10Y is driven, a charging bias of about +600 V and a developing bias of about +400 V are both applied in ON states, the photoconductor cleaning roller 82Y is not applied with the bias in the OFF state, and the photoconductor cleaning blade 87Y is contacted thereto.

In this condition, the liquid developer supplied from the agitating supplying roller 34Y to the developer supply roller 32Y is regulated by the regulating blade 33Y to be in a condition in which the amount of developer is adjusted, and then the liquid developer is transferred to the developing roller 20Y, and further to the portions of the photoconductor 10Y on which the latent image is formed, thus developing the latent image. The potential of the exposed photoconductor 10Y is assumed to be about +100 V. The liquid developer provided to the photoconductor 10Y as the developed image is transferred to the intermediate transfer belt 40 at the primary transfer section 50Y.

The toner and the carrier liquid not primarily transferred and remaining on the photoconductor 10Y are removed by the photoconductor cleaning blade 87Y.

When a jam is detected, the drive of the photoconductor 10Y, the charging bias, and the developing bias are kept OFF while treating the jam.

After the treatment of the jam, an initialization process is commenced in response to a cleaning start instruction. In the initialization process, it is more preferable that the developer compression member 22Y is not applied in order for preventing aggregation of the solid content of the developer.

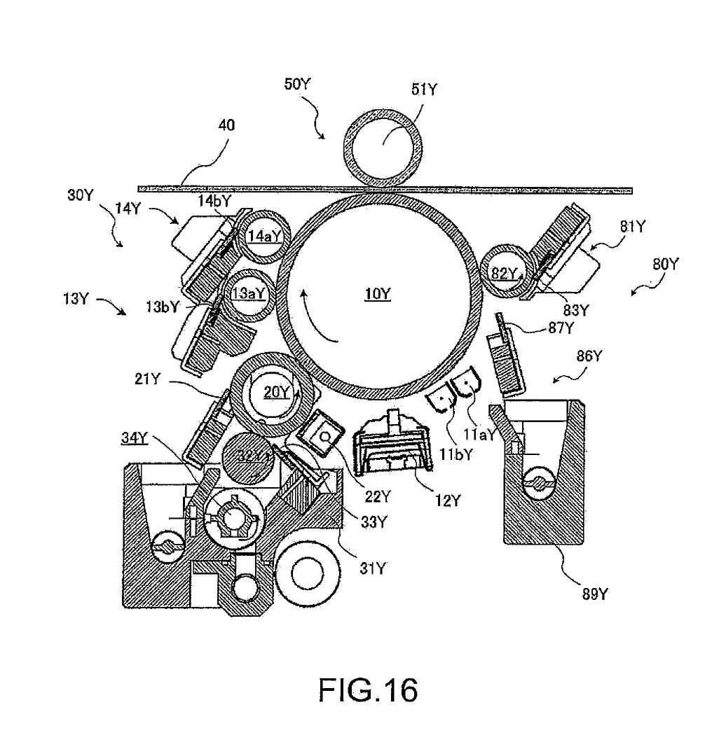

Firstly, the photoconductor 10Y is driven to start the rotational operation. Then, the photoconductor cleaning blade 87Y is separated as shown in FIG. 16 prior to the residual developer on the photoconductor 10Y reaching the photoconductor cleaning section 80Y. Then, charging is turned ON to charge the developer remaining on the surface of the photoconductor 10Y again to the charging polarity in the printing condition. In this case, in order for preventing the solid content of the residual developer on the photoconductor 10Y from being shifted to the side of the photoconductor 10Y, the process can be executed with a weaker charging bias than the charging bias in the printing condition.

After the charging process, by supplying the developer not yet compressed by the developer compression member 22Y from the developing roller 20Y to the photoconductor 10Y, the compressed condition of the developer remaining on the surface of the photoconductor 10Y is weakened to attain the condition in which the cleaning can easily be performed. In this condition, the developer is transferred to the primary transfer section 50Y to decrease the concentration of the solid content of the developer remaining on the photoconductor 10Y. In the present embodiment, the transfer bias of the primary transfer section on this occasion is set to about −400 V.

Subsequently, by applying the bias with the reverse polarity from the primary transfer section 50Y to the photoconductor cleaning roller 82Y, the solid content of the developer remaining on the surface of the photoconductor 10Y and not charged regularly is reduced. In the present embodiment, the bias of the photoconductor cleaning roller 82Y on this occasion is set to about +400 V. Subsequently, as shown in FIG. 13, the photoconductor cleaning blade 87Y is made have contact with the surface of the photoconductor 10Y to remove the developer remaining on the surface of the photoconductor 10Y.

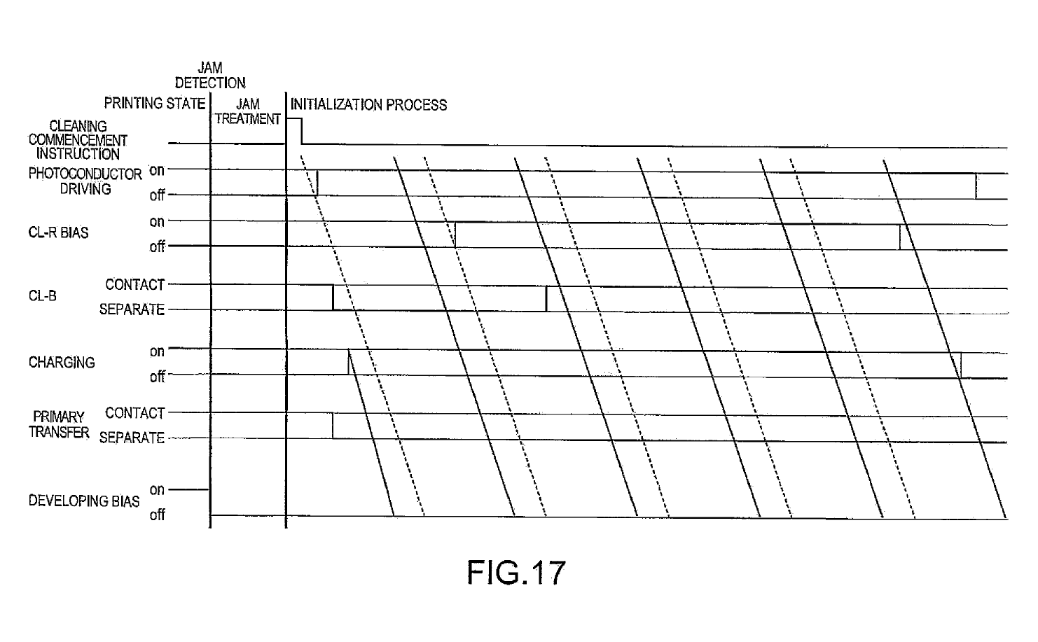

Then, a fifth embodiment of the photoconductor cleaning process control will hereinafter be explained. FIG. 17 shows a timing chart of the fifth embodiment of the photoconductor cleaning control. It should be noted that solid slant lines each represent a front edge position of the charged area, and dotted slant lines each represent a front edge position of the toner not yet transferred.

Firstly, in a printing state, the photoconductor 10Y is driven, a charging bias of about +600 V and a developing bias of about +400 V are both applied in ON states, the photoconductor cleaning roller 82Y is not applied with the bias in the OFF state, and the photoconductor cleaning blade 87Y is contacted thereto.

In this condition, the liquid developer supplied from the agitating supplying roller 34Y to the developer supply roller 32Y is regulated by the regulating blade 33Y to be in a condition in which the amount of developer is adjusted, and then the liquid developer is transferred to the developing roller 20Y, and further to the portions of the photoconductor 10Y on which the latent image is formed, thus developing the latent image. The potential of the exposed photoconductor 10Y is assumed to be about +100 V. The liquid developer provided to the photoconductor 10Y as the developed image is transferred to the intermediate transfer belt 40 at the primary transfer section 50Y.

The toner and the carrier liquid not primarily transferred and remaining on the photoconductor 10Y are removed by the photoconductor cleaning blade 87Y.

When a jam is detected, the drive of the photoconductor 10Y, the charging bias, and the developing bias are kept OFF while treating the jam.

After the treatment of the jam, an initialization process is commenced in response to a cleaning start instruction. In the initialization process, the developer compression member 22Y is not applied in order for preventing aggregation of the solid content of the developer.

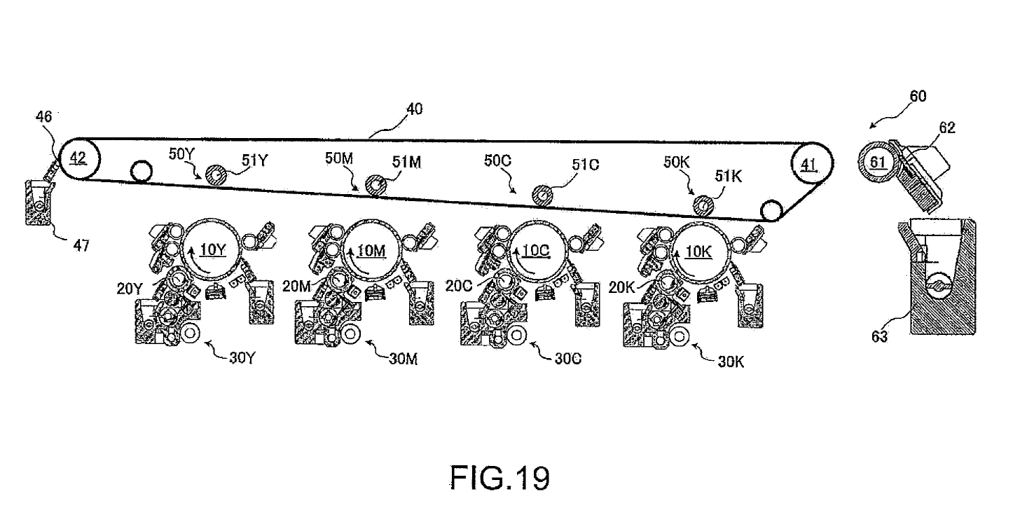

Firstly, the photoconductor 10Y is driven to start the rotational operation, and at the same time, as shown in FIG. 8, the primary transfer sections 50Y, 50M, 50C, and 50K are separated from the belt. On this occasion, as shown in FIG. 19, the secondary transfer section 60 can also be separated therefrom. Then, the photoconductor cleaning blade 87Y is separated as shown in FIG. 16 prior to the residual developer on the photoconductor 10Y reaching the photoconductor cleaning section 80Y. Then, charging is turned ON to charge the developer remaining on the surface of the photoconductor 10Y again to the charging polarity in the printing condition. In this case, in order for preventing the solid content of the residual developer on the photoconductor 10Y from being shifted to the side of the photoconductor 10Y, the process can be executed with a weaker charging bias than the charging bias in the printing condition.

After the charging process, by supplying the developer not yet compressed by the developer compression member 22Y from the developing roller 20Y to the photoconductor 10Y, the compressed condition of the developer remaining on the surface of the photoconductor 10Y is weakened to attain the condition in which the cleaning can easily be performed.

Subsequently, by applying a bias of about −400 V to the photoconductor cleaning roller 82Y, the concentration of the solid content of the developer remaining on the surface of the photoconductor 10Y is lowered. Subsequently, as shown in FIG. 13, the photoconductor cleaning blade 87Y is made have contact with the surface of the photoconductor 10Y to remove the developer remaining on the surface of the photoconductor 10Y.

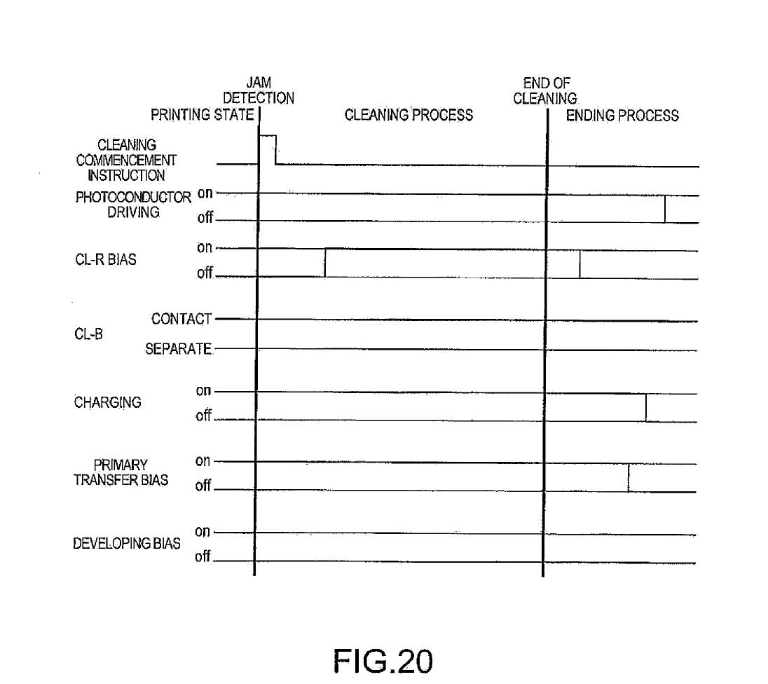

Then, a sixth embodiment of the photoconductor cleaning process control will hereinafter be explained. FIG. 20 shows a timing chart of the sixth embodiment of the photoconductor cleaning control.

Firstly, in a printing state, the photoconductor 10Y is driven, a charging bias of about +600 V and a developing bias of about +400 V are both in the ON states, the photoconductor cleaning roller 82Y has the bias in the OFF state, and the photoconductor cleaning blade 87Y is contacted thereto.

In this condition, the liquid developer supplied from the agitating supplying roller 34Y to the developer supply roller 32Y is regulated by the regulating blade 33Y to be in a condition in which the amount of developer is adjusted, and then the liquid developer is transferred to the developing roller 20Y, and further to the portions of the photoconductor 10Y on which the latent image is formed, thus developing the latent image. The potential of the exposed photoconductor 10Y is assumed to be about +100 V. The liquid developer provided to the photoconductor 10Y as the developed image is transferred to the intermediate transfer belt 40 at the primary transfer section 50Y.

The toner and the carrier liquid not primarily transferred and remaining on the photoconductor 10Y are removed by the photoconductor cleaning blade 87Y.

In the present embodiment, when a jam is detected, the cleaning process and a stopping process are executed in response to a cleaning start instruction. In the cleaning process and the stopping process, the developer compression member 22Y is not applied in order for preventing aggregation of the solid content of the developer.

When the jam is detected, the cleaning process is commenced in response to the cleaning start instruction. Firstly, the photoconductor 10Y is continued to be driven similarly to the printing state. The bias of the developing roller 20Y is assumed to be turned OFF. Further, the bias of the primary transfer roller 51Y is set to −400 V similarly to the printing state, and the bias of about +400 V is applied to the photoconductor cleaning roller 82Y so as to remove the developer not regularly charged. The cleaning process is terminated after the photoconductor 10Y makes at least one revolution.

Then, the stopping process is performed. In the stopping process, the charging section 11Y, the biases of the primary transfer section 50Y and the photoconductor cleaning roller 82Y are turned OFF. After then, the drive of the photoconductor 10Y is stopped. During the above process, the photoconductor cleaning blade 87Y are kept contacting the photoconductor.

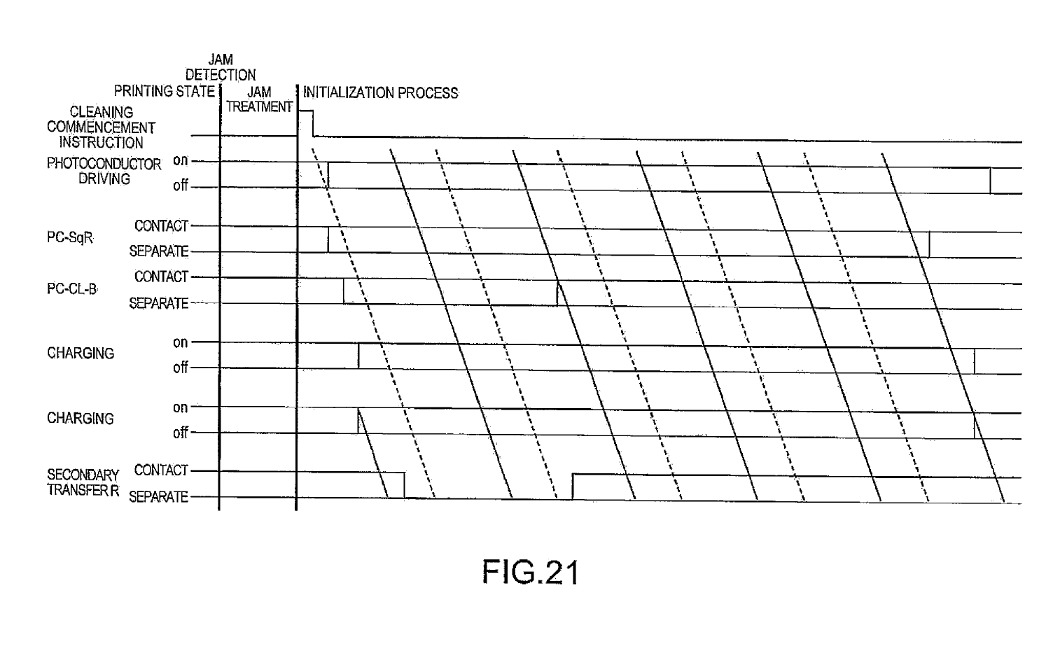

Then, a seventh embodiment of the photoconductor cleaning process control will hereinafter be explained. FIG. 21 shows a timing chart of the seventh embodiment of the photoconductor cleaning control. It should be noted that solid slant lines each represent a front edge position of the charged area, and dotted slant lines each represent a front edge position of the toner not yet transferred.

Firstly, in a printing state, the photoconductor 10Y is driven, a charging bias of about +600 V and a developing bias of about +400 V are both in the ON states, the first squeezing roller 13aY and the second squeezing roller 14aY are contacted, and the photoconductor cleaning blade 87Y is also contacted thereto.

In this condition, the liquid developer supplied from the agitating supplying roller 34Y to the developer supply roller 32Y is regulated by the regulating blade 33Y to be in a condition in which the amount of developer is adjusted, and then the liquid developer is transferred to the developing roller 20Y, and further to the portions of the photoconductor 10Y on which the latent image is formed, thus developing the latent image. The potential of the exposed photoconductor 10Y is assumed to be about +100 V. The liquid developer provided to the photoconductor 10Y as the developed image is transferred to the intermediate transfer belt 40 at the primary transfer section 50Y.

The toner and the carrier liquid not primarily transferred and remaining on the photoconductor 10Y are removed by the photoconductor cleaning blade 87Y.

When a jam is detected, the drive of the photoconductor 10Y, the charging bias, and the developing bias and so on are kept OFF while treating the jam.

After the treatment of the jam, an initialization process is commenced in response to a cleaning start instruction. In the initialization process, the developer compression member 22Y is not applied in order for preventing aggregation of the solid content of the developer.

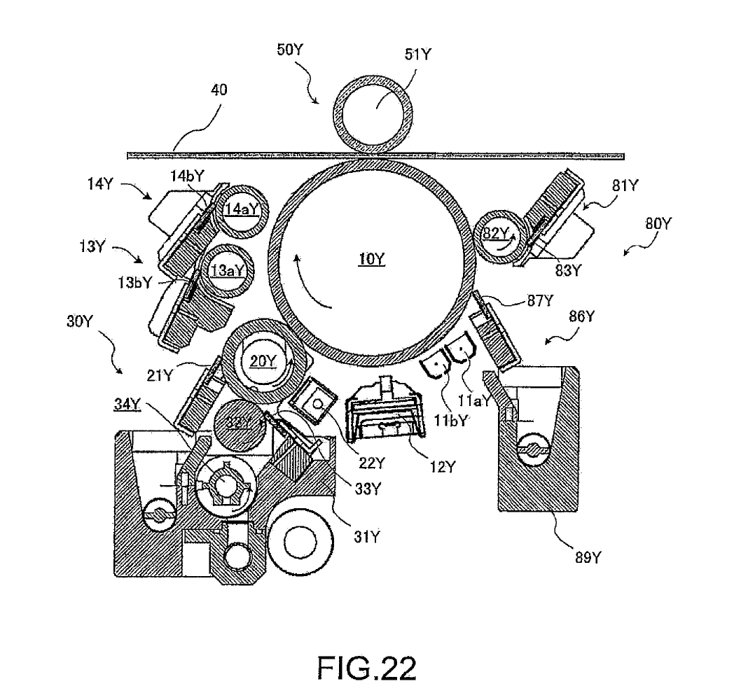

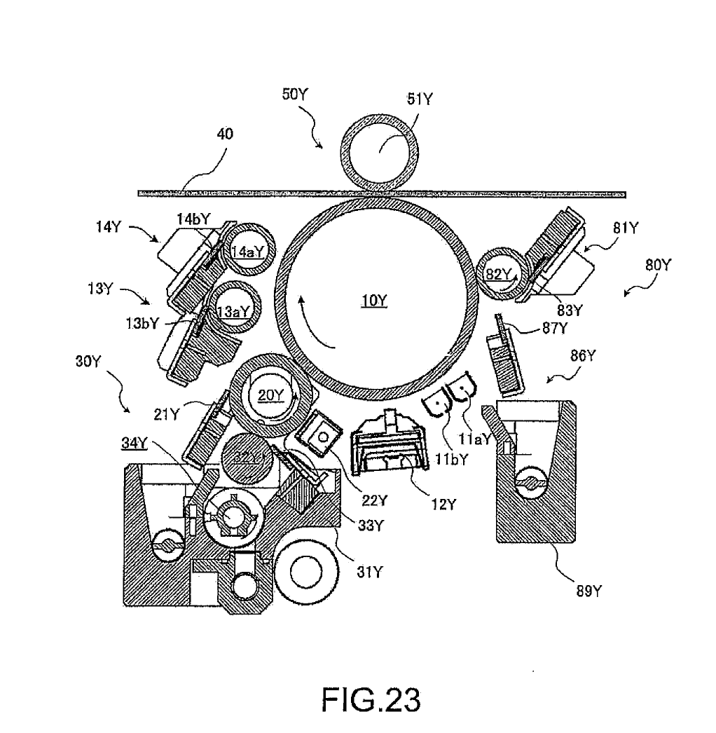

Firstly, the photoconductor 10Y is driven to start the rotational operation, and at the same time, as shown in FIG. 22, the first squeezing roller 13aY and the second squeezing roller 14aY are separated from the photoconductor 10Y to make the carrier liquid of the liquid developer remain thereon to reduce the aggregation of the solid content, thus making it easy to remove the solid content by the photoconductor cleaning blade 87Y. Then, the photoconductor cleaning blade 87Y is separated as shown in FIG. 23 prior to the residual developer on the photoconductor 10Y reaching the photoconductor cleaning section 80Y.

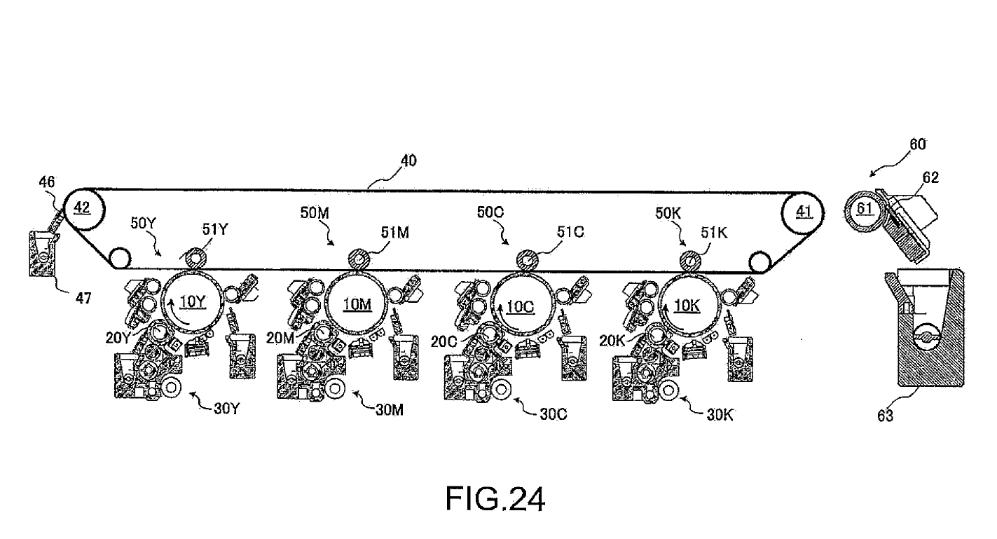

Then, charging is turned ON to charge the developer remaining on the surface of the photoconductor 10Y again to the charging polarity in the printing condition. In this case, in order for preventing the solid content of the residual developer on the photoconductor 10Y from being shifted to the side of the photoconductor 10Y, the process can be executed with a weaker charging bias than the charging bias in the printing condition. Then, as shown in FIG. 24, the secondary transfer section 60 is moved to separate the secondary transfer roller 61 from the intermediate transfer belt 40, and the developer on the intermediate transfer belt 40 is removed by the intermediate transfer belt cleaning blade 46.

After the charging process, by supplying the developer not yet compressed by the developer compression member 22Y from the developing roller 20Y to the photoconductor 10Y, the compressed condition of the developer remaining on the surface of the photoconductor 10Y is weakened to attain the condition in which the cleaning can easily be performed.

Subsequently, by applying a bias of about −400 V to the photoconductor cleaning roller 82Y, the concentration of the solid content of the developer remaining on the surface of the photoconductor 10Y is lowered. Subsequently, as shown in FIG. 13, the photoconductor cleaning blade 87Y is made have contact with the surface of the photoconductor 10Y to remove the developer remaining on the surface of the photoconductor 10Y. Further, the secondary transfer section 60 is moved to make the secondary transfer roller 61 have contact with the intermediate transfer belt 40.

It should be noted that also in the fourth through the sixth embodiments, the first squeezing roller 13aY and the second squeezing roller 14aY can be separated from the photoconductor 10Y in the initialization process. Similarly, the secondary transfer roller 61 can also be separated from the intermediate transfer belt 40. It is preferable that by making the carrier liquid of the liquid developer remain thereon, aggregation of the solid content is reduced, thus making it easy to remove the developer by the photoconductor cleaning blade 87Y and the photoconductor the intermediate transfer belt cleaning blade 46. Further, in the first through the third embodiment, although not shown in the drawings, it is obvious that the initialization process is commenced in response to a certain input such as a cleaning start instruction.

As described above, since there are provided the developing roller 20Y for carrying the liquid developer, the photoconductor 10Y on which the latent image is developed by the developing roller 20Y, the charging member 11Y for charging the photoconductor 10Y, the exposure device 12Y for exposing the photoconductor 10Y, the photoconductor cleaning roller 82Y for applying the bias to clean the photoconductor 10Y, and the photoconductor cleaning blade 87Y being in contact with the photoconductor 10Y for scraping out the developer on the photoconductor 10Y, and the cleaning process for cleaning the photoconductor 10Y is executed in the condition in which the charging bias of the charging member 11Y is applied, the developing roller 20Y is contacted to the photoconductor 10Y, and the bias of the photoconductor cleaning roller 82Y is applied, the cleanability of the residual solid content not transferred is improved, thus the breakage of the protective layer or the photoconductive layer on the surface layer of the photoconductor 10Y can be prevented.

Further, since the developer compression member 22Y for compressing the developer on the developing roller 20Y is provided, and the biases of the developing roller 20Y and the developer compression member 22Y are not applied in the cleaning process, the image can preferably be formed in the printing state, and at the same time, in the cleaning process, the developer is not compressed, thus the cleanability can be improved.

Further, since the developing roller 20Y, the photoconductor 10Y, the charging member 11Y, the exposure device 12Y, the photoconductor cleaning roller 82Y, and the photoconductor cleaning blade 87Y are provided for each of the plurality of colored developers, the cleaning process corresponding to each of the colors can be executed.

Further, since in the cleaning process, after the photoconductor cleaning blade 87Y is separated from the photoconductor 10Y, and the bias is applied to the photoconductor cleaning roller 82Y, the photoconductor cleaning blade 87Y is then contacted to the photoconductor 10Y, the photoconductor cleaning blade 87Y is contacted in the condition in which the photoconductor cleaning roller 82Y applies the bias to the developer to make the developer easy to be scraped out, thus the cleanability can be improved.

Further, since the transfer member having the transfer bias applying section for applying the bias for transferring the image on the photoconductor 10Y is provided, and the cleaning process is executed while the transfer member is separated from the photoconductor 10Y, it is reduced that the developer is attached to the transfer member,

Further, since the photoconductor cleaning roller 82Y applies the bias with the same polarity as the polarity of the bias to be applied to the transfer bias applying section when transferring the image on the photoconductor 10Y, it becomes easy to recover the developer with the photoconductor cleaning roller 82Y, thus the cleanability can be improved.

Since the transfer member having a transfer bias applying section for applying a bias for transferring an image on the photoconductor 10Y is provided, and the cleaning process is performed while the transfer member has contact with the photoconductor 10Y, the developer on the photoconductor 10Y is transferred to the transfer member, thus the cleanability of the photoconductor 10Y can be improved.

Further, since the photoconductor cleaning roller 82Y applies the bias with the reversed polarity from the polarity of the bias to be applied to the transfer bias applying section when transferring the image on the photoconductor 10Y, the developer regularly charged is transferred to the transfer member while the developer not regularly charged is recovered by the photoconductor cleaning roller 82Y, thus the cleanability can be improved.

Further, since the squeezing members 13Y, 14Y for recovering the carrier liquid on the photoconductor 10Y are provided, and the squeezing members 13Y, 14Y are separated therefrom in the cleaning process, the recovery of the carrier liquid is reduced, it becomes easy to scrape out the developer with the photoconductor cleaning blade 87Y or the like.

Further, since the squeezing members 13Y, 14Y are provided with the first squeezing roller 13aY and the second squeezing roller 14aY, the carrier liquid can sufficiently be removed in the printing state, thus the image quality can be improved.

What is claimed is:

1. An image forming device comprising:
a developer carrier for carrying a liquid developer;
a latent image carrier to which a latent image is developed by the developer carrier;
a charging member for charging the latent image carrier;
an exposure device for exposing the latent image carrier;
a latent image carrier cleaning roller for applying a bias to clean the latent image carrier;
a latent image carrier cleaning blade having contact with the latent image carrier and for scraping out the liquid developer on the latent image carrier; and
a cleaning process control section for cleaning the latent image carrier in a condition in which a charging bias of the charging member is applied, the developer carrier has contact with the latent image carrier, and the bias of the latent image carrier cleaning roller is applied to the latent image carrier cleaning roller.

2. The image forming device according to claim 1, further comprising:
a developer compression member for compressing the developer on the developer carrier,
wherein the cleaning process control section keeps stopping applied of biases to the developer carrier and the developer compression member.

3. The image forming device according to claim 1,
wherein the developer carrier, the latent image carrier, the charging member, the exposure device, the latent image carrier cleaning roller, and the latent image carrier cleaning blade are provided for each of a plurality of the liquid developers with respective colors.

4. The image forming device according to claim 1, further comprising:
a transfer member having a transfer bias for applying a bias for transferring the image on the latent image carrier,
wherein the cleaning process control section executes the cleaning process while separating the transfer member from the latent image carrier.

5. The image forming device according to claim 4,
wherein the latent image carrier cleaning roller applies the bias with the same polarity as the polarity of the bias applied to the transfer bias applying section when the image on the latent image carrier is transferred.

6. The image forming device according to claim 1, further comprising:
a transfer member having a transfer bias applying section for applying a bias for transferring the image on the latent image carrier,
wherein the cleaning process control section executes the cleaning process while the transfer member has contact with the latent image carrier.

7. The image forming device according to claim 6,
wherein the latent image carrier cleaning roller applies the bias with the reverse polarity from the polarity of the bias applied to the transfer bias applying section when the image on the latent image carrier is transferred.

8. The image forming device according to claim 1, further comprising:
a squeezing member for squeezing a liquid developer on the latent image carrier,
wherein the cleaning process control section separates the squeezing member.

9. The image forming device according to claim 8,
wherein the squeezing member includes a first squeezing roller and a second squeezing roller.

10. A control method of an image forming device, comprising:
(a) providing a developer carrier for carrying a liquid developer, a latent image carrier to which a latent image is developed by the developer carrier, a charging member for charging the latent image carrier, an exposure device for exposing the latent image carrier, a latent image carrier cleaning roller for applying a bias to clean the latent image carrier, and a latent image carrier cleaning blade having contact with the latent image carrier and for scraping out the liquid developer on the latent image carrier;
(b) applying a charging bias of the charging member;
(c) making the developer carrier have contact with the latent image carrier;
(d) applying the bias of the latent image carrier cleaning roller; and
(e) cleaning the latent image carrier, wherein step (e) is executed while steps (b), (c), and (d) are executed.

11. The control method of an image forming device according to claim 10,
wherein step (e) includes
(e1) separating the latent image carrier cleaning blade from the latent image carrier,
(e2) applying the bias to the latent image carrier cleaning roller, and
(e3) making the latent image carrier cleaning blade have contact with the latent image carrier, and
step (e3) is executed after steps (e1) and (e2) are executed.

12. The control method of an image forming device according to claim 10, further comprising:
(f) providing a transfer member having a transfer bias applying section for applying a bias for transferring the image on the latent image carrier;
(g) separating the transfer member from the latent image carrier; and
(h) the latent image carrier cleaning roller applying the bias with the same polarity as the polarity of the bias applied to the transfer bias applying section when the image on the latent image carrier is transferred.

13. The control method of an image forming device according to claim 10, further comprising:
(f) providing a transfer member having a transfer bias applying section for applying a bias for transferring the image on the latent image carrier;
(i) the transfer member having contact with the latent image carrier; and
(j) the latent image carrier cleaning roller applying the bias with the reverse polarity from the polarity of the bias applied to the transfer bias applying section when the image on the latent image carrier is transferred.

14. The control method of an image forming device according to claim 10, further comprising:
(k) separating a squeezing member for reducing the carrier liquid on the latent image carrier from the latent image carrier.
